(19) United States
(12) Patent Application Publication
(10) Pub. No.: US 2008/0100433 A1
(43) Pub. Date: May 1, 2008

(54) Method and Write/Read Station and Transponder of an RFID System for Data Transmission

(76) Inventor: Markus Desch, Niedernhausen (DE)

Correspondence Address: ST. ONGE STEWARD JOHNSTON & REENS, LLC, 986 BEDFORD STREET, STAMFORD, CT, 06905-5619, US

(21) Appl. No.: 11/925,298

(22) Filed: Oct. 26, 2007

(30) Foreign Application Priority Data
Oct. 27, 2006 (DE) 10 2006 051 387.8
Sep. 26, 2007 (DE) 10 2007 046 190.0

(51) Int. Cl. G08B 26/00

(52) U.S. Cl. 340/505

(57) ABSTRACT

The invention relates to a method for data transmission between a write/read station of an RFID (radio frequency identification) system and at least one RFID transponder, wherein the write/read station emits a query in order to demand an initial reply from the at least one transponder and wherein the write/read station emits an operating mode instruction before, with, or after the query, which instruction instructs every transponder that receives this query and operating mode instruction to emit its initial reply to the write/read station without or with a checksum.

### CROSS-REFERENCE TO RELATED APPLICATIONS

The present application claims priority of German patent application No. 10 2006 051 387.8 filed on Oct. 27, 2006, and German patent application No. 10 2007 046 190.0 filed Sep. 26, 2007 the content of which is incorporated herein by reference.

### FIELD OF THE INVENTION

The invention relates to a method by which a data transmission can be carried out between a write/read station of an RFID (radio frequency identification) system and at least one RFID transponder, as well as a write/read station and a transponder of an RFID system for using the method.

### BACKGROUND OF THE INVENTION

With customary methods today for data transmission using RFID systems, as described for instance in the specifications of EPCGlobal under the title “EPC Radio Frequency Identity Protocols Class 1 Generation-2 UHF RFID Protocol for Communications at 890 MHZ-960 MHz Version 1.0.9” or in the international standard ISO/IEC 18000-6 for communication at frequencies of 860 to 930 MHz, the first data transfer is conducted from a transponder to the write/read station after the write/read station has sent a query to all transponders assumed to be in its detection range.

The EPCGlobal specification, for instance, describes a method by which the write/read station first sends out a query, which is defined as a defined binary bit sequence. Thereupon the transponders that have received the query reply to it within a defined time frame with a binary coded initial reply made up of a preamble, a random number, and an end of frame indicator. If the write/read station has received the initial reply of a transponder, it sends out a binary coded select block, which contains among other things the Random number contained in the initial reply. In this way a connection is established between the write/read station and transponder, and the transponder become aware that the write/read station will begin communicating with it.

If a transponder has received from the write/read station the select block with the random number originally generated from it, it in turn sends further information to the write/read station.

If the write/read station had not received the initial reply correctly and at once sent a number to the transponder that is not identical with the random number generated by the transponder, then the transponder would put out no further information. This absence of further information from the intended transponder is thus evaluated by the write/read station as an incorrectly received initial reply, and the write/read station can start the process again by sending a new query.

If several transponders situated in the detection range of the write/read station receive the query, then these transponders send their initial reply almost simultaneously to the write/read station. However, because of the nearly simultaneous transmission of the initial reply, the individual initial replies frequently overlap one another to such an extent that the write/read station is incapable of determining whether it has received the initial reply from a single transponder or whether the information it has received is made up of the overlapping of several initial replies.

The result is that the write/read station integrates the intended random number into the select block and transmits it in order to establish a communication with the transponder, from which the random number was supposedly generated. However, because this random number was not generated by any of the transponders found in the detection range of the write/read station, the connection is not correctly made and the write/read station must initiate the establishment of a new connection by sending a new query, with the disadvantage that the establishment of a connection to a transponder can be strongly delayed by a high number of failed attempts and a quick data exchange is prevented.

However, the initial reply of a transponder can also be disturbed by other events such as interfering signals, which are emitted by other senders or electronic devices, to such an extent that the write/read station cannot correctly receive the initial reply.

To make it possible for a write/read station to determine whether the information it receives was correctly transmitted, in many RFID systems known in the art the information to be transmitted is supplemented with check sums, error corrector codes, or other redundant data by means of which the write/read station can verify that the received data are error-free. These methods are summarized hereafter under the term “checksums”. One frequently employed method for ensuring a data transmission is the formation and transmission of a checksum according to the cyclic redundancy check (CRC) method.

Supplementing the actual information with a checksum constructed in any manner whatsoever has the disadvantage, however, that the duration of a data transmission is prolonged by the time required to transmit the checksum, leading to an overall longer transmission time.

The technical problem that inspired the invention consists in producing a method that ensures a reliable and at the same time rapid establishment of communication between a write/read station and a transponder. In addition, the invention provides a write/read station as well as a transponder for applying the method.

### SUMMARY OF THE INVENTION

This technical problem is solved by means of a method having the characteristics given in claim 1, as well as a write/read station with the characteristics according to claim 8 and a transponder having the characteristics according to claim 11.

The inventive method for data transmission between a write/read station of an RFID system and at least one RFID transponder, in which the write/read station puts out a query to request an initial reply from at least one transponder, is characterized in that the write/read station, along with or after the query, sends out an operation mode instruction that notifies every transponder that receives this query and operating mode instruction to send its initial reply to the write/read station with or without a checksum.

This makes it possible for the communication between the write/read station and the transponder to be established quickly and reliably.

The invention provides a method, a write/read station, and a transponder for applying the method, all of which make possible a switching between a transmission process with checksum transmission or without checksum transmission. Thus the invention uses the advantages of RFID systems, which operate without checksums, and thereby can work very rapidly on disturbance-free data transmission paths, and the advantages of data transmission methods with checksums, which still work reliably in a disturbed environment.

In addition, the invention provides a method with which an adaptive selection of one of the previously described transmission methods can take place, and which thus makes possible a selection of the optimal method according to the situation.

For this purpose the invention provides that an operating mode instruction is emitted by the write/read station and switches the operating mode of the transponders that receive this operating mode instruction to the operating mode with checksum transmission or to the operating mode without checksum transmission.

In a first advantageous embodiment of the inventive method, the query contains the digitally coded operation mode instruction, which can be executed as a bit for instance, and which informs the transponders that receive the query that they should send their initial reply to the write/read station with or without a checksum.

This has the advantage that the duration of the transmission of the query does not change and, with corresponding establishment of the coding, the inventive method has no influence on transponders that are already in circulation.

In another advantageous embodiment of the inventive method, an operating mode instruction is sent out by the write/read station at a time shortly or immediately before the sending of the query, so that all transponders receiving this operating mode instruction switch their operating mode and reply to the following query according to the operating mode instruction with or without checksum.

In an additional embodiment, the write/read station only emits an operating mode instruction if the transponders are to transmit their initial reply with a checksum. If the transponders transmit their initial reply without checksum, the write/read station sends no operating mode instruction.

This embodiment has the advantage that the query does not modify any already existing RFID systems and thus the mixing operating of the transponders and write/read station becomes possible with and without operating mode switching.

In an additional advantageous embodiment, the transmission of the operating mode instruction is made at a different time in, or in connection with, another communication process. For instance, the operating mode instruction can be sent separately after the reception of an initial reply, in order to enhance the separate transmission of a checksum by a transponder.

In another especially advantageous embodiment, the write/read station at first works in the particular operating mode without checksum. In this case the write/read station emits a query and receives initial replies simultaneously from all transponders in the detection area. Because of these initial replies, the write/read station emits a select block, which contains data from the initial reply of a transponder. However, if the write/read station on this select block receives no answer from a transponder, it activates the operating mode with check sum by emitting the corresponding operating mode instruction so that the next data transmission sequence can be executed with higher transmission security.

This adaptive behavior has the advantage that the data transmission, to the extent possible, is carried out with the rapid transmission method without checksum, and a switching to the secure but slower method with checksum occurs only in the case in which a faulty data transmission can be assumed.

With the inventive method it is possible that the write/read station selects from the aforementioned possibilities the operating mode that seems the most suited to the particular situation. The write/read station can thus adaptively select the operating mode.

The inventive write/read station for applying the inventive method is characterized in that the write/read station is configured as a write/read station that switches the mode of operating.

In an additional embodiment the write/read station can adaptively execute the switching of the operating mode. For this purpose the write/read station is equipped with a device that makes possible the analysis of received signals or of received data.

Evaluation of the received data has the advantage that the adaptive switching can be executed with already existing write/read stations, because the processes necessary for the evaluation can be executed in software.

Evaluation of the reception signals makes it possible for the write/read station at any time to conduct an analysis of the interfering signals contained in the reception signal, with the advantage that the write/read station can decide at an early stage whether it must operate with the operating mode with the checksum or with the operating mode without checksum.

An inventive transponder for applying the inventive method is distinguished in that it is constructed as a transponder that receives the operating mode instruction and switches the operating mode. Depending on the operating module, the transponder sends a reply with or without a check sum.

Further characteristics and advantages of the invention can be seen with reference to the appended illustrations, in which embodiments of the inventive method are depicted in exemplary manner.

### BRIEF DESCRIPTION OF THE DRAWINGS

FIG. 1 shows schematically the process of a communication between the write/read station and a transponder without checksum.

FIG. 2 shows schematically the process of a communication between a write/read station and a transponder with checksum.

FIG. 3 shows schematically the process of a communication between a write/read station and a transponder with checksum.

FIG. 4 shows schematically the process of an adaptive switching of the operating mode.

FIG. 5 shows a block diagram of a write/read station.

FIG. 6 shows a block diagram of a write/read station with analysis device.

FIG. 7 shows a block diagram of a transponder.

### DETAILED DESCRIPTION OF THE INVENTION

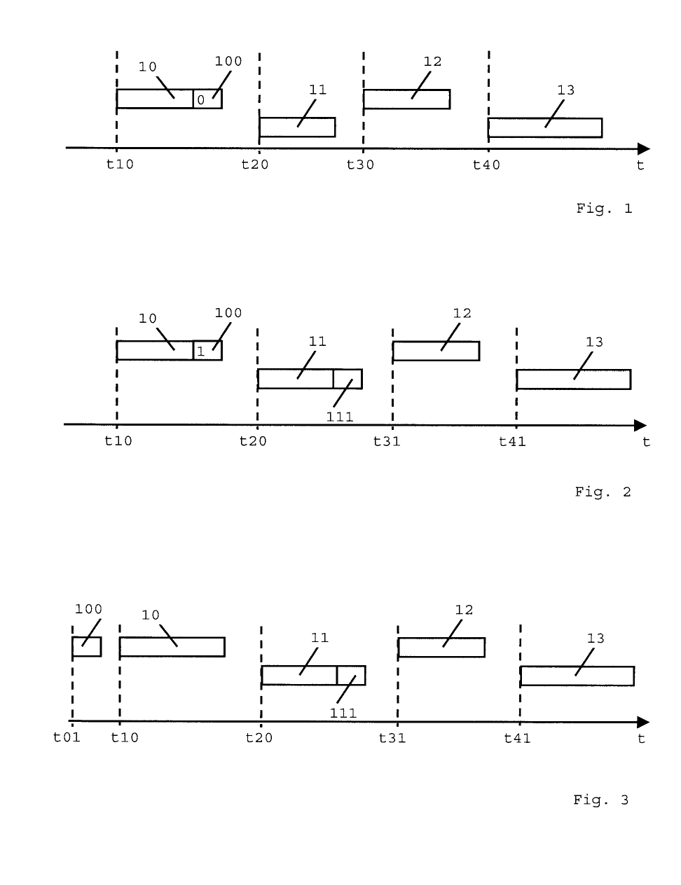

In FIG. 1 the write/read station at time t10 emits query 10, containing an operating mode instruction 100. In the illustrated example, the 0 sign of the operating mode instruction 100 symbolizes that the data transmission is to take place without a checksum. At time t20, at least one transponder emits its initial replay 11 to query 10 without checksum. The initial reply 11 contains a code of the transponder, which for example can be a random number. The write/read station extracts from the initial reply 11 the random number generated by the transponder and emits it to the intended transponder as a component of the select block 12 at the time t30. The transponder, which recognizes in the select block the random number it generated, then at time t40 sends the data block 13 back to the write/read station.

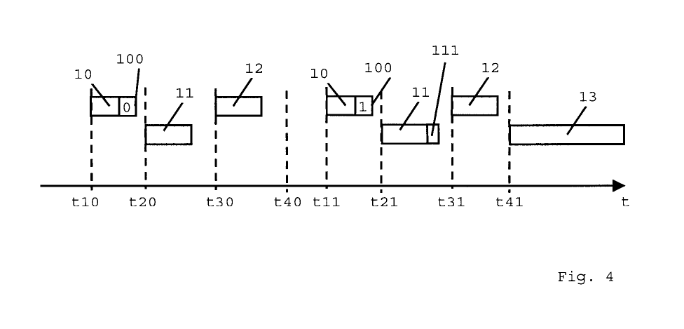

In the process shown in FIG. 2, the operating mode instruction 110 contained in the query 10 is set at 1. The 1 sign in operating mode instruction 110 symbolizes that the data transmission is to take place with checksum. The query is emitted by the write/read station at time t10. Because of the operating mode set in the query 10, at least one transponder at time t20 emits its initial reply 11 with attached checksum 111. After the write/read station has verified the checksum and established that it has received an error-free initial reply 11, it takes from the initial reply 11 the random number generated by the transponder and sends this number as a component of the select block 12 at time 31 to the transponder supposedly communicating with the write/read station. Because the initial reply 11 of the transponder has been extended by the checksum 111, the emission process of select block 12 takes place only at time 31 and thus later than with a transmission of the initial reply 11 without checksum 111. The transponder, which recognizes in select block 12 the random number it generated, thereupon at time 41 sends the data block 13 back to the write/read station.

In the process shown as an example in FIG. 3, the write/read station at time t01 at first emits the operating mode instruction 100 and a short time later, at time t10, emits the query 10, which in this example contains no operating mode instruction 100. Because of the previously separately emitted operating mode instruction 100, at least one transponder at time t20 emits its initial reply 11 with attached checksum 111, after it has received query 10. After the write/read station has examined the checksum 111 and established that it has received an error-free initial reply 11, it takes from the initial reply 11 the random number generated by the transponder and emits it as a constituent part of the select block 12 at time t31 to the transponder that is supposedly communicating with the write/read station. The transponder, which recognizes in the select block 12 the random number it has generated, thereupon at time 41 emits the data block 13 back to the write/read station.

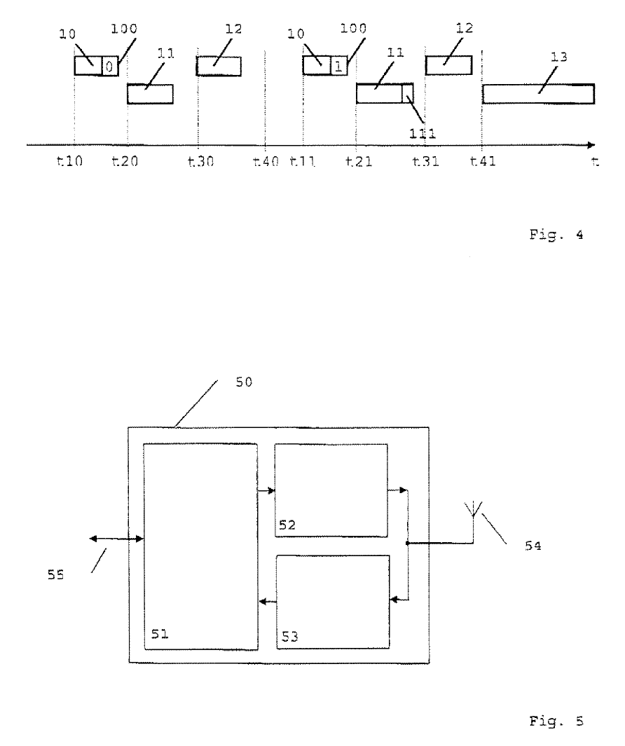

FIG. 4 presents as an example a possible pathway with adaptive switching of the operating mode. Here the write/read station at first emits a query 0 with an operating mode instruction 100, which instructs the transponders to transmit their initial reply 11 without checksum. From the initial reply 11, the write/read station takes the random number, which has been generated by a transponder supposedly communicating with the write/read station and emits said number as a constituent part of the select block 12. Because the write/read station, however, has received the random number defectively and the select block 12 it has emitted contains a random number that was not generated by any transponder found in the reception area, it receives in reply to the select block 12 no data block that would have been expected otherwise at time t40. Because of the absent data block, the write/read station recognizes that a transmission error may have occurred and emits the next query 10 with an operating mode instruction 100 that instructs the transponders to transmit their initial reply 11 with checksum. Now at least one transponder emits its initial reply 11 with attached checksum 111. After the write/read station has verified the checksum and established that it has received an error-free initial reply 1, it takes from the initial reply the random number generated by the transponder and emits this number as a constituent part of the select block to the transponder that supposedly communicates with the write/read station. The transponder, which recognizes in the select block 12 the random number it has generated, thereupon emits the datablock 13 back to the write/read station.

The write/read station 50 described as an example in FIG. 5, which is capable of switching the operating mode instruction, consists of a control and evaluation unit 51, an emitting device 52, a receiving device 53, an emitting and receiving antenna 54, and an interface 55. The emitting and receiving antenna 54 here can be executed as a frame antenna, a loop with several turns, a surface emitter, a dipole, or in another form that is equipped to transmit energy and signals in the frequency range for an RFID system in which the write/read station 50 operates.

The control and evaluation unit 51 can receive commands by way of the interface 55, for instance a command for reading a transponder. After reception of this command, the control and evaluation unit 51 activates the transmitting device 52 in order to generate a carrier signal and starts the transmission of data, for instance a query 10. In a first query 10, the operating mode instruction 100 can, for instance, call for the initial reply 11 of a transponder without checksum. This query 10, like all other transmission data, is transmitted by the transmitting and receiving antenna 54. If a transponder happens to be in the reception area of the transmitting and receiving antenna 54, said transponder is supplied with electrical energy by the transmitting and receiving antenna 54. If the transponder in this position receives a query 10, then it transmits its initial reply, which is conducted by the transmitting and receiving antenna 54 to the receiving device 53. In the receiving device 53 the signals received by the transponder are prepared in such a way that they can be evaluated by the control and evaluation unit 51.

After evaluation of the initial reply 11, the control and evaluation unit 51 checks whether this is the initial reply 11 of a transponder that supposedly communicates with the write/read station. If the evaluation of the initial reply concludes with a positive result, the control and evaluation unit 51 initiates the transmission of a select block 12 in order to call for a data block 13 from the transponder. If the control and evaluation unit 51 receives no data block 13 upon the transmission of the select block 12, it can set the operating mode instruction 100 for the next query in such a way that a transponder that receives this query 10 transmits its initial reply 11 equipped with a checksum 111. The initial reply 11 sent by a transponder again, by means of the transmitting and receiving antenna 54 and the receiving device 53, arrives at the control and evaluation unit 51, which executes a review of the checksum 111 and thereupon decides whether it is transmitting a select block 12 to the transponder from which it has received the initial reply.

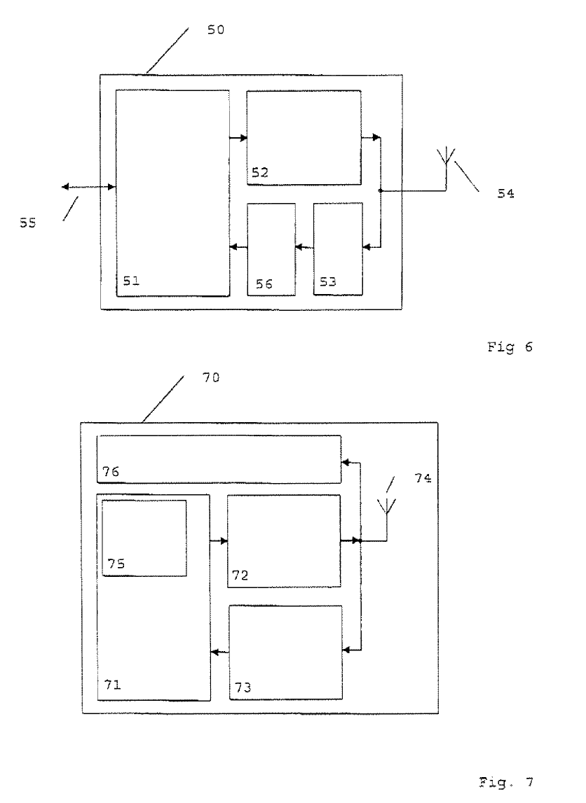

FIG. 6 shows an additional embodiment of a write/read station 50. This write/read station comprises an additional analysis device 56, which in this case is positioned between the receiving device 53 and the control and evaluation unit 51. The analysis device 56 has the function of assessing the receiving signals qualitatively to determine whether, and to what degree, interfering signals are contained in the reception signal.

FIG. 7 depicts an example of the construction of a transponder 70 that is capable of receiving an operating mode instruction 100 and to switch its operating mode according to the operating mode instruction 100. For this purpose the transponder 70 has at its disposal a receiving device 73, an evaluation and control unit 71, in which in this example a data memory 75 is integrated, an transmitting device 72, an transmitting and receiving antenna 74, and an energy memory 76. If the transponder 70 comes into the transmission field of a write/read station, electrical energy is coupled by the transmitting and receiving antenna 74 and conducted to the energy memory 76, which supplies all components of the transponder with electrical energy as long as the transponder happens to be in the transmission field of a write/read station. The data memory 75 is a non-volatile memory, for instance an EEPROM, which contains its stored contents even when no additional electrical energy is supplied to it. If the transponder 70 receives signals by means of the transmitting and receiving antenna 74, these signals are prepared by the receiving device 73 and conveyed to the evaluation and control unit 71. If the evaluation and control unit 71 recognizes data in these signals that constitute a command to the transponder 70, such as a command to emit reply data, it prepares the reply data and initiates the emission of the reply data, which then are conveyed by the transmitting device 72 and the transmitting and receiving antenna 74. In the evaluation of the received data, the evaluation and control unit 71 can also recognize whether an operating mode instruction is directing it to emit its initial reply 11 with or without checksum 111.

1. A method for data transmission between a write/read station of an RFID (radio frequency identification) system and at least one RFID transponder, wherein the write/read station transmits a query in order to demand an initial reply from the at least one transponder,
characterized in that
the write/read station before, with, or after the query transmits an operating mode instruction, which instructs every transponder that receives this query and operating mode instruction to emit its initial reply to the write/read station without or with a checksum.

2. A method according to claim 1, characterized in that the operating mode instruction is configured as binary 1-bit information.

3. A method according to claim 1, characterized in that the operating mode instruction is a constituent part of the query.

4. A method according to claim 1, characterized in that the write/read station transmits the operating mode instruction in a time sequence immediately before the emission of the query.

5. A method according to claim 1, characterized in that the write/read station only transmits the operating mode instruction when a trans-ponder is to transmit the initial reply with a checksum.

6. A method according to claim 1, characterized in that the write/read station adaptively modifies the operating mode instruction.

7. A method according to claim 6, characterized in that the write/read station instructs the at least one transponder with the help of the operating mode instruction to transmits its next initial reply with a checksum only after a failed communication construction.

8. A write/read station for applying the method according to claim 1, having a control and evaluation unit, an emitting device, a receiving device, a transmitting and receiving antenna, and an interface,
characterized in that
the write/read stationary is constructed as a write/read station that switches the operating mode and transmits the operating mode instruction.

9. A write/read station according to claim 8, characterized in that the write/read station comprises an analysis device for the received data and/or signals.

10. A write/read station according to claim 8, characterized in that the write/read station is configured as a write/read station that can switch from an operating mode without checksum into an operating mode with checksum and vice versa.

11. A write/read station according to claim 1, characterized in that it is established in the control and evaluation unit whether an operating mode instruction is emitted and if so, which instruction is emitted.

12. A transponder for applying the method according to claim 1, having a receiving device, a transmitting device, a transmitting and receiving antenna, and an energy memory,
characterized in that
the transponder comprises an evaluation and control unit and is constructed as a transponder that receives the operating mode instruction and switches the operating mode.

13. A method according to claim 2, characterized in that the operating mode instruction is a constituent part of the query.
